(19) United States
(12) Patent Application Publication
(10) Pub. No.: US 2010/0017265 A1
(43) Pub. Date: Jan. 21, 2010

(54) SYSTEM AND METHOD FOR PRODUCT PURCHASE RECOMMENDATION

(76) Inventors: Nehemiah Weingarten, Kefar Sava (IL); Oren Butchmits, Tel Aviv (IL)

Correspondence Address: Nehemiah Weingarten, #9 Sharet St., Apt 16, Kefar Sava, 44458, omitted

(21) Appl. No.: 12/505,501

(22) Filed: Jul. 19, 2009

Related U.S. Application Data
(60) Provisional application No. 61/082,202, filed on Jul. 20, 2008.

(51) Int. Cl. G06Q 30/00; G06Q 50/00; G06Q 10/00

(52) U.S. Cl. 705/10; 705/14.38; 705/14.27

(57) ABSTRACT

A system and method for recommending products at the retail point of decision is disclosed.

### CROSS REFERENCE TO RELATED APPLICATIONS

This application claims the benefit of provisional patent Ser. No. 61/082,202 filed Jul. 20, 2008 by the present inventors.

### FIELD OF THE INVENTION

This invention generally relates to retail store purchase decisions. More specifically, means that enable shoppers to select more suitable products at the point of decision are disclosed.

### BACKGROUND OF THE INVENTION

Shoppers in modern retail stores are faced with many products to choose from. Some may be loyal to a specific brand, some search for the cheapest product, some look for certain features, and others base their decision on perceived quality of the product.

The Internet has advanced consumers' purchasing power in several ways. First, it allows people to do the actual buying from home, as clearly exemplified by amazon.com. Secondly, it enables consumers to compare similar items based on various parameters, for example digital cameras in dpreview.com. Thirdly, it allows the collective intelligence of the crowds to rate products and provide reviews that aid futures buyers in decision making, as exemplified by sites such as epinions.com.

While some products lend themselves quite easily to online purchase (books, electronics, DVDs) for other products (grocery, clothing, furniture) the majority of shoppers still visit physical retail establishments. In many case, less information is available at the physical store compared to what is available online. The product manufacturer provides most of the information about a product, and in some cases the retailer provides information as well. The information may obfuscate or omit details about negative aspects of the product.

For some shoppers, the information available in the store is sufficient to make a decision. Other shoppers prepare in advance and learn about the product at home, online, and then make the final purchase decision at the physical store, after some real world interaction with it, for example, researching a car model online for best mileage performance, and then going out for a test drive when visiting a dealership.

With the advent of Internet enabled mobile phones such as Apple's iphone, Google' Android phones, and RIM's Blackberry, shoppers can actually access review sites on their handheld device while at the store. The drawback is that most of the shopping websites do not provide a mobile adapted version of their service, and their regular sites are not well suited for displaying large amounts of information on a small mobile device screen.

Some items for sale, by their nature, are high involvement products such as cars, home appliances, books and personal electronics. This is due to one or more factors, such as high price, low frequency of purchase, usage pattern, and emotional connection. For these items, many consumers prepare themselves with information in advance of the purchase. Other products, for example grocery items, require low involvement and thus for most shoppers warrant much less preparation and dedicated time for product research in advance of purchase.

We shall define high involvement products as products for which the buyer is prepared to spend considerable time and effort in research. Low involvement products shall be defined as products which are bought frequently and with a minimum of thought and effort about them because they are not of vital concern nor have any great impact on the consumer's lifestyle.

While online information exists that can aid shoppers in making purchase decisions for such low involvement products, their nature is such that for most people it is not worth the time and effort. However, even low involvement products engage shoppers to some extent, usually in the very brief time from spotting a product on the retail shelf until deciding to purchase it and placing it in the shopping cart. For example, a shopper in a supermarket may pick up a packaged box of breakfast cereal, examine it briefly and then decide to buy it.

Low involvement products are in many cases commodities, for example bread, pasta sauce, milk, and the like. Therefore, product manufacturers rely on branding and packaging to make their products more attractive. The package design is augmented by textual messages that inform shoppers about the product's benefits, for example nutrition and health benefits. In addition to messaging on the product package, retailers may add additional signage or incentives to buy one product or the other.

The collective goals of the manufacturer and the retailer is to maximize the number of times a shopper will decide to buy a product, mostly based on the few seconds of interaction with the retailers' and manufacturers' marketing messages. This, however, is not necessarily in the shoppers' best interest. For example, a sweetened cereal with high amounts of sugar may be portrayed as a cheap and healthy product, thus inducing a shopper to select the item. However, more thorough research may lead the shopper to believe otherwise and choose a reduced sugar alternative.

Existing art addresses product selection at the point of decision through the use of dedicated hardware devices. For example U.S. Pat. No. 4,780,599 discloses the use of a hand-held bar code reading device to retrieve product information for users. FR-A-2702583 discloses the use of a hand-held barcode reader used to make purchasing decisions based on the price of selected products. U.S. Pat. No. 6,375,077 discloses the use of a hand-held barcode reader used to make purchasing decisions based on ethical considerations. U.S. Pat. No. 5,841,115 discloses an apparatus and method for providing nutritional information about a food product to shoppers.

There are several shortcomings to the aforementioned solutions. Firstly, the information provided does not suggest an alternative product to the shopper if the nutrition information is not satisfactory. Secondly, some are based on dedicated hardware that needs to be introduced to the retail-shopping ecosystem. The cost of such hardware and the education of consumers to have such hardware handy make these solutions impractical in many cases. Thirdly, these solutions do not utilize the collective intelligence of many consumers, for example to advise how tasty a non-sugared cereal may be. Additionally, some of the solutions require expensive updating of the product database.

In the area of food and health products, a special consideration is added to the purchase decision, that does not come into play when purchasing books, electronics and the like. Food and health products that are ingested, affect people's bodies in various ways, with both short term and long-term health effects. People, over the past few decades, have become more aware of the possible negative and positive health consequences of certain types of food. For example, trans-fat, found in some snack foods and margarine, is considered by many nutrition experts a negative element to be avoided because it may lead to heart disease. Omega-3 on the other hand, is considered a very healthy polyunsaturated fat that may contribute to health. Manufacturers, seeing shoppers' growing awareness of health issues, try to soothe their worries by highlighting their products' health benefits and diminishing any negative nutritional aspects.

In the U.S., the Nutrition Labeling and Education Act of 1990 (NLEA) has created a standard requirement for all food manufacturers to provide a label on packaged food items with a list of ingredients and nutritional information. The labels include a large amount of information. Unfortunately, almost 2 decades after the law was passed, many consumers are still unable to understand the meaning of the food labels, let alone decide if a product suits their dietary and health needs. In addition, a shopper may have difficulty comparing two similar products because each may have advantages in different comparison parameters that are not easily weighted.

Several recent initiatives are trying to tackle the complexity of food labels by providing simple guidance for shoppers. The Hannaford chain of supermarkets has introduced “Guiding Stars”, a system where a food item may receive zero to three stars based on its nutritional value.
(http://www.hannaford.com/Contents/Healthy_Living/Guiding_Stars/index.shtml). ONQI, Overall Nutritional Quality Index, is another rating system giving a score of 1-100 to every food item that may be found in a supermarket.
(http://www.griffinhealth.org/Research/ONQI.aspx). Another rating system, Smart Choices, is being supported by major food manufacturers
(http://www.smartchoicesprogram.com). Still another rating system is being developed by a team led by Professor Adam Drewnowski, Director Nutritional Sciences, Washington University.

The above solutions have a few shortcomings. Smart Choices and Guiding Stars have been developed by and in cooperation with manufacturers and retailers; as a result, consumers may question the objectivity of their proprietary nutrition scoring system. In addition, the score each product receives is not personalized to a specific person's dietary needs or specific medical condition and may not enable an optimal choice. Lastly, the product scoring system allows a shopper to decide whether to purchase a product or not. It does not, however, suggest an alternative product in case the original product is not selected. If there are more than a few choices on the shelf, then the shopper needs to go over each and every product until making a positive buy decision. This may be tiresome in categories with many products, for example breakfast cereals, which may fill up an entire supermarket aisle.

Existing art includes food related websites that do not easily enable a consumer to make a purchase decision. Zeer.com is a social network focused on food. The user-generated recommendations are focused on a foods taste rather than its health benefits. Nutritiondata.com includes a database of many food items and extensive tools for analyzing a specific product. However, there is an information overload not suited for most consumers. In addition, this website is not suitable for use with a mobile device when shopping in a retail store.

A prototype of a mobile phone advisory service has been demonstrated at UC Berkeley (http://nature.berkley.edu/infolab/projects/informationtoolsdevelopmentproject). However, while information about a specific product is displayed, there is no actionable information about what alternative to buy and no incentive mechanism.

Currently there is no simple, fast, solution for assisting food shoppers in selecting the most appropriate product for themselves and their families at the point of decision in a retail store.

### SUMMARY OF THE INVENTION

Although a preferred embodiment described herein deals with food product selection, it will be apparent to those skilled in the art, that this patent may be adapted for other applications and is therefore not limited to food products.

In a preferred embodiment, the present invention describes a system and method for using a personal mobile device to identify a shopper and a product, calculate relevant information, and display it on the mobile device. The relevant information may include summarized product information, alternative product suggestions, personal recommendations, additional product/nutrition information, and incentives to switch to an alternative product. The relevant information is presented to the shopper in real time.

In some embodiments, the relevant information may include product information based on many resources and statistics gathered from manufacturers, retailers, distributors, governmental offices, academic institutions, consumer groups, shoppers, and any other sources providing information about the product. In some embodiments, a community of shoppers provides information that can be aggregated, such as a tastiness rating of a food product. In some embodiments, the relevant information is calculated based on the shopper's medical, dietetic, and lifestyle profiles. In some embodiments, information may include modification information, for example adding honey to unsweetened cereal for taste, recipes using a certain product, complementary products, and the like. In some embodiments, the relevant information is calculated based on none, some, or all of a shopper's personal profile information.

In a preferred embodiment, a shopper uses software on a personal mobile device, for product selection assistance. While browsing food items at a supermarket, a shopper may be interested in information about a specific product on display. The shopper uses the mobile device to acquire the product's unique identifier. The product identifier and the shopper's identity are transmitted to a knowledge base. The knowledge base looks up the product information and the shopper profile. The product information and shopper profile are then processed to create product information. The product information is then presented on the shopper's mobile device. The information may include, but is not limited to, product summary, product alternatives, incentives, and additional data.

### BRIEF DESCRIPTION OF THE DRAWINGS

FIG. 1 is a schematic diagram of an embodiment of the product purchase recommendation system.

FIG. 2 is a schematic diagram of an embodiment depicting the flow of information while making a purchase decision.

FIG. 3 is a schematic diagram of the information displayed to a shopper in an embodiment of the invention.

### DETAILED DESCRIPTION OF THE INVENTION

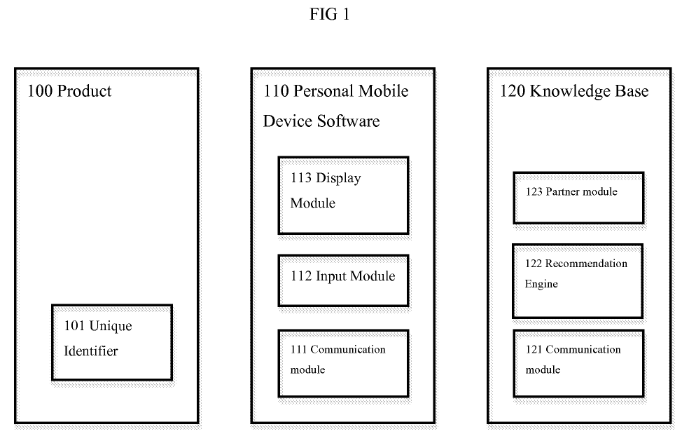

FIG. 1 is a schematic diagram of a preferred embodiment of the present invention. Product 100 can be identified by its unique identifier 101. In some embodiments, unique identifier 101 is a barcode. The barcode may be one-dimensional such as UPC, EAN, GS-1, or other coding systems, two-dimensional, for example a QR code, Semacode, Ultracode, or of any other coding system, this invention in not so limited. In other embodiments, the unique identifier 101 may be a near field communications module such as an RFID tag or any other proximity/hand free identification method. In still some other embodiments, the unique identifier 101 may be the sum of some visible and physical traits of the product 100. In yet still some other embodiments, the unique identifier 101 may be the product name or the product package. In some embodiments, the unique identifier 101 is not present on the product but rather on the shelf or basket where the product is displayed, for example in the produce section of a supermarket.

In a preferred embodiment, Personal Mobile Device Software 110 is software running on a mobile device such as a mobile phone. In other embodiments, personal mobile device software 110 may be running on a personal digital assistant, music player, digital camera, personal barcode scanner, portable computer, or any other consumer electronic device.

In some embodiments, personal mobile device software 110 is a dedicated application. In other embodiments, it is an application preloaded on a mobile phone. In still other embodiments, it is an application loaded on a memory card used by a mobile phone. In yet still other embodiments it is a mobile Internet browsing application.

Communications module 111 enables personal mobile device software 110 to transmit and receive information to and from Knowledge Base 120.

Input module 112 includes a means for obtaining the unique identifier 101 from product 100. In one embodiment, input module 112 receives characters typed in from a mobile phone keyboard providing unique identifier 101's numerical digits. In some embodiments, the shopper verbally states the code into the mobile device.

In a preferred embodiment, input module 112 receives an image from a mobile phone camera, for example an image of a barcode or an image of the numerical digits appearing in proximity to the barcode. Software processing of the image then produces the required numerical code, for example in the case of an image of numerical digits, by using Optical Character Recognition (OCR) techniques. The software processing may be executed on the mobile device or elsewhere.

In another embodiment, input module 112 may receive data from the mobile phone wireless communication element such as cellular receiver, FM receiver, RFID receiver, Bluetooth receiver, and the like, receiving information transmitted from unique identifier 101.

In a preferred embodiment, display module 113 is responsible for formatting information for display on a mobile phone screen. In other embodiments, display module 113 may format information for an audio speaker, or any other means of transferring information from the mobile device to the shopper.

Knowledge base 120 is one or more server hosted software programs and databases containing records of products and their attributes. In one embodiment relating to food products, product attributes may include some or all of the following—product unique identifier, ingredients, nutrition information, allergy information, intolerance information, chemical treatment information, the number of miles the food has traveled, use of child labor, fair trade, manufacturer or subcontractor information, religious issues, public health warnings, recent product and manufacturer news, price, retail availability, similar products, historical product information, recent changes to the above, and any other information pertaining to the manufacturing of the food product.

In a preferred embodiment, the knowledge base 120 further includes one or more databases of shopper profiles that include some or all of the following—age, sex, family status, household status, dietary restrictions, dietary preferences, dietary history, medical history, current health information, allergy information, intolerance information, height, weight, brand affinities, personal mobile device software 110 usage history and any other information about the shopper and additional household members that may aid in product recommendation.

Communications module 121 enables knowledgebase 120 to transmit and receive information to and from personal mobile device software 110. The communications means may be over a cellular network, thru Wi-Fi, Wi-max, Bluetooth, via cable, or any other means that enable client/server communication.

In some embodiments, knowledge base 120 resides partially or fully in a mobile device and the communications modules 121 and 111 are unified as a data bus. In some embodiments the knowledge base 120 resides partially or fully on a memory card that may be used by the mobile device.

In a preferred embodiment, the knowledge base 120 is dynamically updated. The knowledge base 120 may be updated with respect to new products, product changes, product deletions, additional product characteristics, shopper information, shopper history, shopper reviews, product recommendation history, and the like. The knowledge base 120 may be updated by parties commercializing this invention as well as by shoppers and other users of the invention.

In some embodiments, the knowledge base 120 is accessed from other software than personal mobile device software 110, such as software running on a PC or laptop computer.

In a preferred embodiment, recommendation Engine 122 receives as input a unique product identifier and a unique shopper identifier. Recommendation engine 122 calculates and prepares information for presentation by personal mobile device software 110. Information includes some or all of the following—summarized and formatted product attributes as mentioned above, product score in various categories, product ranking compared to similar products, product match for a specific shopper profile, suggestions for similar products with higher scores in some categories, additional product information and links, and additional personalized information.

In a preferred embodiment, recommendation engine 122 calculates the overall nutritional quality of a food product, and outputs one or more numeric scores. In some embodiments, parts of the shopper's profile are also used to calculate the one or more numeric scores.

In some embodiments, recommendation engine 122 can incorporate promotional content from partner module 123. Promotional content may include targeted advertisements, coupons, sponsorship messages, and the like.

In some embodiments, shoppers may contribute product information to knowledge base 120, for example user rating on the tastiness of a food item, adding a new product information, adding pricing information, and the like.

In a preferred embodiment, recommendation engine 122 provides one or more alternative product suggestions. In some embodiments, the order of presentation of the alternative products is determined randomly. In some embodiments, the order of presentation is determined by the fit to the shopper. In some embodiments, the presentation is determined in conjunction with partner module 123, for example, if an alternative product is calculated to be a suitable alternative product by recommendation engine 122, and, according to partner module 123, the manufacturer has decided to spend on promoting the alternative product to the shopper, then the alternative product will be presented more prominently than other alternative products.

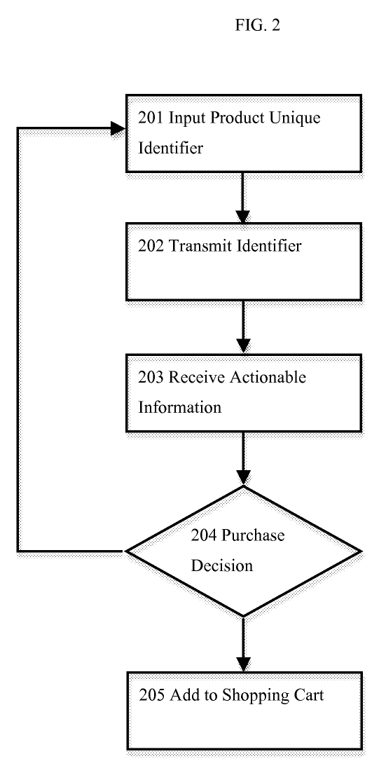

FIG. 2 is a schematic diagram depicting information flow during the purchase decision process, from a shopper's perspective in a preferred embodiment. In step 201, the shopper inputs a product unique identifier 101 to personal mobile device software 110 in order to query product 100.

In step 202, the unique identifier is transmitted to knowledge base 120. In some embodiments, additional information is transmitted, such as the shopper's personal profile or part of it, geographical location, retail store identification, location within the store, time and date, and other information.

In step 203, the shopper receives actionable information onto the mobile device and reviews it.

In step 204 the shopper is better prepared to make a purchase decision. If the information leads the shopper to choose the examined product 100, shopper may add the product to the shopping cart in step 205. If, as the result of steps 201-204, the shopper chooses to examine a different product, the process starts again at step 201, with a different product.

In a preferred embodiment, this process occurs when the shopper is at the point of decision in the retail store, for example in front of a shelf of pasta sauces.

In some embodiments, the process occurs while the shopper is waiting in line for the cashier, after product 100 has been selected. In such cases, alternative product recommendations might not be utilized as the shopper does not or cannot leave the queue. The alternative product information may be saved by the shopper and used on the next shopping trip.

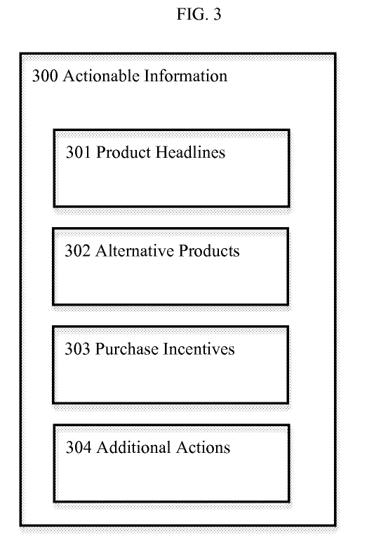

FIG. 3 is a schematic block diagram of the information provided to the shopper in a preferred embodiment of the present invention. Actionable information 300 is divided into several parts. Product headlines 301 is a concise and targeted summary of product 100's traits. In some embodiments, these may be generalized, for example stating that a food product contains a high amount of trans-fat. In other embodiments, the summary is tailored to a specific user profile. For example, a person allergic to peanuts is provided a peanut advisory as part of every product summary, whereas for the general population such a warning is not necessary in the summary. In some embodiments, graphical information is used to illustrate a point. For example, instead of specifying that a sweetened cereal contains 12 grams of sugars in a 28 gram serving, a graphic icon showing a bowl with 3 tablespoons of sugar may be a more effective means to convey the message that the cereal has a high sugar content. In some embodiments, product headlines 301 point out to an illogical serving size, for example a bag of potato chips with a serving size of only 11 chips.

Alternative products 302 may be none, one, or many products fulfilling similar shopper needs as the product 100. Alternative products 302 are suggested to the shopper based on various factors. In one embodiment, the recommendation engine 112 calculates a score for product 100 and for each similar product in the knowledge base 120. Some or all products with a better score than product 100 are then recommended to the shopper as alternative products 302. In some embodiments, recommendation engine 112 includes the shopper's personal profile in the calculation of alternative products 302. For example, a vegetarian shopper that scans a frozen classic pizza will not receive recommendations for a pepperoni pizza, even if it scores higher from a nutrition perspective than the classic pizza.

In some embodiments, the shopper's personal profile may include temporary medical conditions such as pregnancy, iron deficiency, or permanent medical conditions such as diabetes, and the like. In some embodiments, the personal profile may include an allergy to foods such as mollusks, peanuts, and the like. In some embodiments the personal profile may include food category intolerance such as lactose intolerance, gluten intolerance and the like. In some embodiments there may be more than one personal profile, for example when a shopper is part of a household where each member has different dietary needs. Further, there may be defined a household profile which takes into account the various needs and profiles of each of the household members.

In a preferred embodiment, the shopper's personal profile includes some or all of the shopper's usage history of the knowledge base 120, including but not limited to products reviewed, products suggested, alternative actions taken by the shopper, and the like.

The prominence given to each of alternative products 302 may be determined randomly, by order of fit to a shopper's personal profile, based on promotional spending by product manufacturer, a combination of the above, or any other means.

Purchase incentive 303 is a means to motivate the shopper to purchase one or more alternative products 302. In one embodiment, the purchase incentive 303 is a coupon providing a financial incentive. In another embodiment, purchase incentive 303 is non-financial, for example, recognition that the shopper is making a smart and healthy choice. In some embodiments the incentive 303 may be tied to a third party service such as weight reduction support group, or a loyalty program of a retailer or manufacturer.

In some embodiments, the use of knowledge base 120 is part of a game, or educational game. Incentive 303 is a means to reward a game player for correct product choices, for example by receiving points, advancing to a higher level, receiving virtual gifts, virtual badges and the like.

Additional Actions 304 includes additional information and actions that are result of the product 100 query. This includes any additional information that may be useful to the shopper in making a purchase decision, for example in-depth details about product 100's ingredients and nutrients, recipe ideas, complementary products to purchase, links to informative websites, and the like. In some embodiments, information such as ingredient definition, general nutrition guidelines, and other in depth health related knowledge is provided. Actions that may be performed by the shopper include none, some or all of the following—adding a product to a list, removing a product from a list, choosing to redeem a coupon, executing nutrition calculations, rating the product information 300 or parts of it in terms of usefulness or other parameters, sending information to a third party such as a friend, inviting another shopper to use the software on another mobile device, sending a message to the product manufacturer, sending a message to the retailer, responding to a message from the product manufacturer, responding to a message from the retailer, completing a questionnaire, and any other action pertaining to the decision to purchase a product or the usage of the personal mobile device software 110.

In some embodiments, in addition to the food product information provided to the shopper, information about the retail establishment where the product was queried is provided. This information may include some or all of the following—special offers, store coupons, loyalty plans, pricing, retailer branded products, general business practices, employee relations, product sourcing, relationships with suppliers, recent news, and any other information that may be of interest to a shopper in making a purchase decision. In some embodiments, the information may include a recommendation on a suggested supermarket for a specific shopper.

It can be appreciated by those skilled in the art that this invention is not limited to food products sold in retail locations such as supermarkets and grocery stores. In some embodiments, the food products may be served in a sit-down restaurant, quick serve restaurant, fast food chain restaurant, drive in food service, catering service, vending machines, or any other prepared food serving establishment.

In some embodiments, this invention provides guidance for the purchase of non-food grocery items. In still other embodiments, this invention provides guidance for the purchase of health products and drugs.

In some embodiments of this invention, some or all parts of knowledge base 120 reside locally on a personal mobile device used to execute personal mobile device software 110, or in a memory card that may be accessed by personal mobile device software 110.

In some embodiments, the shopper may virally spread the personal mobile device software 110 to another shopper by initiating an action from the shopper's personal mobile device software 110 or elsewhere.

In some embodiments, software similar to personal mobile device software 110 may execute on a PC or a laptop computer, where a webcam or the like is used to identify a product.

In some embodiments, where barcodes are unavailable, object recognition technology may be used to identify products, for example fruit and vegetable products. Those skilled in the art will appreciate that due to specific colors and shapes of produce, this is a rather simple object recognition task.

In some embodiments, additional tools may be provided to the shopper as part of personal mobile device software 110, or separately, for example a body mass index calculator, a daily caloric intake calculator, weights and measurements conversions, and the like.

In some embodiments, each of the shoppers' product information queries and suggested alternatives are saved for use at a later date, for example, to construct one or more shopping lists.

In some embodiments the aggregate queries and recommendations are collected and analyzed to detect trends and preferences. This information may be used to improve the result of recommendation engine 122.

We claim:

1. A method comprising the steps of:
identifying a product,
correlating said product's attributes with other products' attributes and with a consumer's attributes, and
outputting information, whereby said information enables making a more informed product purchase decision.

2. The method of claim 1, wherein said product is a food product.

3. The method of claim 2, wherein said product's attributes comprise at least nutrition information.

4. The method of claim 2, wherein said consumer's attributes comprise at least a dietary requirement.

5. The method of claim 1, wherein said consumer's attributes comprise at least a personal preference.

6. The method of claim 1, wherein said consumer's attributes comprise at least a history of said consumer's previous use of said method.

7. The method of claim 1, wherein said identifying further comprises using a personal mobile device in close proximity to said product, said mobile device comprising means to deduce said product's identity based on at least a unique detail of said product.

8. The method of claim 7, wherein said at least a unique detail is said product's barcode.

9. The method of claim 1, wherein said information is used by said consumer.

10. The method of claim 1, wherein said information is used by another consumer for the benefit of said consumer.

11. The method of claim 1, wherein said information comprises at least product headlines.

12. The method of claim 11, wherein said product headlines comprise at least a comment on the actual consumed serving size of said product compared to the serving size indicated on said product's nutrition facts label.

13. The method of claim 1, wherein said information comprises at least a recommendation to select at least one alternative product from a group of said other products.

14. The method of claim 13, wherein at least one of said at least one alternative product is presented more prominently than other said at least one alternative product, based on an agreement with a third party.

15. The method of claim 14, wherein said third party is a product manufacturer.

16. The method of claim 13, wherein said information further comprises an incentive to select said at least one alternative product.

17. The method of claim 16, wherein said incentive comprises at least a price discount.

18. The method of claim 16, wherein said incentive comprises at least earning loyalty club points.

19. The method of claim 16, wherein said incentive comprises at least earning social recognition.

20. The method of claim 1, wherein said information comprises at least a promotion from a third party.

21. The method of claim 20, wherein said promotion comprises at least an advertisement.

22. The method of claim 20, wherein said promotion comprises at least a coupon.

23. The method of claim 20, wherein said third party is a product manufacturer.

24. The method of claim 20, wherein said third party is a product seller.

25. A system, comprising a knowledge base and a remote interface communicatively coupled to each other, said remote interface comprising a means to identify a product, wherein said remote interface provides a product's identity to said knowledge base and receives information from said knowledge base, said information correlated to said product's attributes, other products' attributes, and a consumer's attributes.

26. The system of claim 25, wherein said remote interface is operationally coupled to a personal mobile device.

27. The system of claim 25, wherein said remote interface is operationally coupled to a mobile phone.

28. The system of claim 25, wherein said information comprises at least a recommendation to select at least one alternative product from a group of said other products.
